(19) United States
(12) Patent Application Publication
(10) Pub. No.: US 2005/0159551 A1
(43) Pub. Date: Jul. 21, 2005

(54) Sprayable low volatility in-mold gel coat compositions

(76) Inventors: Patrick E. Mack, Milford, MA (US); Mitchell D. Smith, Abingdon, VA (US)

Correspondence Address: Brian M Dingman;Mirick O'Connell DeMallie & Lougee, 1700 West Park Drive, Westborough, MA, 01581-3941, US

(21) Appl. No.: 10/505,642

(22) PCT Filed: Feb. 19, 2003
(86) PCT No.: PCT/US03/04500

Related U.S. Application Data
(60) Provisional application No. 60/357,321, filed on Feb. 19, 2002.

(51) Int. Cl. C08L 67/00

(52) U.S. Cl. 525/165; 525/418; 525/437

(57) ABSTRACT

A thermosettable in-mold exterior gel coat composition exhibiting low or no volatile organic content for use with molded plastic substrates, includes fiber reinforced substrates. The gel coat composition is composed of an ethynically unsaturated polyester resin and utilizes as a co-polymerizable reactive diluent therein an acrylate or methacrylate ester component having from 2 to 4 carbon atom alkyl substituent radicals depending thereon, coupled with a 5 to 10 carbon-atom-containing mono or dicyclic alkyl or alkenyl ester radical, and carrying in turn one or more optional alkyl substituents of from about 1 to 3 carbon atoms. In a process for the application of the exterior gel coat to molded plastic substrates, including fiber reinforced substrates, the substrate is applied to said gel coat while it is in a tacky state of only partial cure so as to achieve a bonding between the substrate and the gel coat.

This application is based upon and claims the priority of the same applicants' U.S. Provisional application of the same title filed Feb. 19, 2002, Ser. No. 60/357,321, the entire disclosure of which is incorporated herein by reference.

### FIELD OF THE INVENTION

The present invention relates to a thermosettable in-mold exterior coating gel coat composition for molded plastic substrates. More particularly, the invention relates to the use of low volatility mimetic analogs to volatile reactive diluents such as styrene to enhance sprayability in low and/or no volatile organic content (“VOC”) gel coat formulations.

### DESCRIPTION OF THE PRIOR ART

Fiber reinforced resin composite structures take many shapes and forms in applications ranging from bathtubs to aircraft. Typically in the construction of these shapes and forms fibers are laid up into an open mold of the desired shape. This dry fiber reinforcement is then wet out with resin using manual or instrumented techniques, and the resin is allowed to cure to form the composite to the desired shape, and the resulting structure is removed from the mold for use.

To provide a durable and/or esthetic surface to the part being manufactured, an in mold coating, often referred to as a gel coat, is sprayed onto the mold surface prior to application of the fibers and/or resin. Ethynically unsaturated polyester resins are typically used together with a reactive diluent, usually a volatile unsaturated organic monomer, which is generally referred to as a reactive diluent. The unsaturated organic monomer copolymerizes with the polyester resins to form a gel coating and may be used in other applications such as pultrusion, resin lamination, sheet molding compounding, bulk molding compounding, etc. As generally used in the past, exemplar volatile reactive diluents include styrene, alpha-methylstyrene, vinyltoluene, and divinyl-benzene.

During the curing stage some of the volatile organic monomer is lost to the atmosphere. Due to environmental concerns of such organic compounds, legislation has been enacted which requires reduction in the amount of volatile organic compounds that may be released to the atmosphere.

The composite fiberglass manufacturing industry has been identified as a major source of hazardous air pollutants (HAP). In 1997, approximately 19.7 Million pounds, of the total of about 45.5 Million pounds of airborne styrene emissions, or 43%, was from fiberglass boat manufacturing sources alone. (Data from the EPA Toxic Release Inventory and EPA 40 CFR Part 63 RIN 2060-AG67).

Under the National Emissions Standards for Hazardous Air Pollutants (NESHAP) the EPA is issuing regulations to reduce emissions of toxic air pollutants, such as styrene, from this industry. NESHAP implements section 112(d) of the Clean Air Act by requiring all major sources to meet HAP emissions standards reflecting the application of the maximum achievable control technology (MACT).

At its most basic level, MACT will require, e.g., boat builders utilizing gel coats to reduce annual styrene emissions by roughly 20 percent. Current fabrication techniques, the chemistry of those systems currently in use, and their dependence on styrene, make this a difficult task. Additionally, even though manufacturers may be able to meet NESHAP standards for emissions, they may still have trouble complying the enhanced or different standards set by individual states and municipalities, which are typically more stringent. This is evident today in that current capacity constraints in the marine industry have little to do with the size of plant facilities. Rather, the caps on emissions create limitations on the number of boats that can be built per time period with open mold lamination.

This invention principally provides a breakthrough “drop in place” non-HAP gelcoat system.

### CURRENT AND PRIOR ART TECHNOLOGY SUMMARY

Gelcoats for composite articles are generally spray-applied and then cured, with multi-component formulations consisting of a base resin system having incorporated therein various fillers, pigments, and other additives. The selection of these constituents plays an important roll in the determining the end properties of the gelcoat and its suitability for a given application. Constituents for a major application the baseline formulations of this invention are derived, in part, from the demands of the marine marketplace, and other composite-utilizing industries.

The use of styrene as a co-monomer for gel coat formulations is and has been attractive for several reasons that stem from its lengthy history of use and accordingly a predictability in application. The spray-ability of a system, or its ability to atomize is in part dependent on the cohesive nature of the resin system being spayed. The more cohesive the system the harder it can be to atomize. However, previous attempts to use styrene alternatives have met with little success, particularly in gel coat applications.

To a large extent, it is well-known that unsaturated ester-based polymers are conventionally utilized as the primary backbone in gel coat composite systems technology. As a result, these systems are polar in nature. However, polar molecules tend to arrange themselves head to tail, positive to negative, and these orientations tend to increase intermolecular attraction and cohesion. These dipole-dipole forces, called Keesom interactions, are symmetrical attractions that depend on the same properties in each molecule. Styrene's dissimilarity in structure to the unsaturated esters disrupts the Keesom interactions in the system, thus reducing intermolecular cohesion.

Previous attempts to introduce non-styrene based gel coats have utilized structures similar in nature to that of the unsaturated ester resin. Although the viscosity of a given system may be reduced using this technique, the Keesom interactions, and thus cohesive interactions, may not be. Because Keesom interactions are related to molecular arrangements, they are temperature dependent. Higher temperatures cause increased molecular motion and thus a decrease in Kessom interactions. The resulting systems may then be sprayable only with the addition of heat.

However, in most cases the addition of heat to gel coating systems imposes additional capital investment and quality control issues to the standard shop environment. Other low-VOC techniques, such as reducing the overall Keesom forces by reducing the overall molecular weight of the system, have tended to yield highly cross-linked and brittle materials with inferior physical performance.

Accordingly, in light of the above discussion, the prior art has faced the problem of finding an acceptable replacement for styrene or its counterparts in the formulation of exterior gel coat compositions for application to fiber-reinforced composites.

### OBJECTS OF THE INVENTION

An object of the present invention is to provide a technique and gel coat formulations that will overcome the shortcomings of the prior art.

An object of the present invention is to provide a composition of matter that is exemplar of the types of materials that may be used as Keesom disruption reactive diluents.

Other objects and advantages of the present invention will become apparent from the following description, Various additional objects, features and attendant advantages of the present invention will become more fully appreciated from the following specification and it is intended that these and additional objects and advantages shown hereinafter be within the scope of the present invention.

### SUMMARY OF THE INVENTION

In view of the foregoing disadvantages inherent in the known techniques for reducing the volatile content of gel coats now present in the prior art, the present invention provides a new technique for gel coat formulation by using Keesom disruption monomers as reactive diluents.

The general purpose of the present invention, which will be described subsequently in greater detail, is to provide a new technique and an application of materials for the formulation of low or non volatile gel coats that has many of the advantages of low or non volatile gel coats heretofore and many novel features that result in a composition which is not anticipated, rendered obvious, suggested, or even implied by any of the prior art gel coats, either alone or in any combination thereof.

To attain this, the present invention generally comprises of the use of non-volatile Keesom disruption reactive diluents that mimic the activity of previously used volatile reactive diluents such as styrene. This eliminates the need for formulation techniques that may compromise the low or non-volatile nature of the product, such as the alternative addition of a percentage of volatile reactive diluent to overcome spraying issues, or the need to add heat to the gel coat during processing to overcome spaying issues.

The approach of this invention is to utilize non-volatile, styrene mimetics based on certain commercially available acrylic ester cyclic or non-cyclic compounds as replacements for the styrene. By using these structural mimetics to styrene, the Keesom interactions can be reduced, yielding a room temperature sprayable gel coat.

The invention has qualitatively and quantitatively developed several baseline gel coat formulations that have the requisite sprayability and unsaturated resin system compatibility, and physical performance. These systems are based on materials with minimum or no VOCs. Among others, this invention has targeted the large market segment, such as marine white gel coat exterior, however color variations, also for marine or other exterior use are also feasible.

Shown below is the chemical structure of styrene, a volatile reactive gel coat diluent and co-monomer, with a flash point of 32° C.

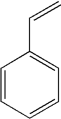

Next shown is the chemical structure of a presently preferred C₁₀-isobomyl methacrylate ester, a low volatile Keesom-disruptive mimetic to styrene, having a flash point of 101° C. the preferred key material used according to this invention. 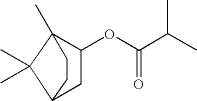
As an example the solvent parameter of this isobornyl methacrylate ester is close to that of styrene at 8.1 δ(cal/cm³)½ to 8.7 δ(cal/cm³)½ respectively.
Selection of Co-Monomer

In the research effort leading to this invention, to reduce the Keesom interactions within the base resin system, a number of acrylate and methacrylate functional structural analogs to styrene were evaluated. These structural styrene analogs are here forth referred to as K-Monomers. The K-Monomer solvent parameter relative to styrene was used as a first order selector criteria for functionality. Second order selection criteria included the analogs' classification with regards to their HAP, toxicity, cost/availability, and effectiveness. Preference is given to aliphatic analogs for their enhanced UV stability over aromatic analogs, such as styrene. From this effort a number of materials were evaluated for their requisite properties.

The resulting acrylate ester compounds that may be used in accord with the principles of this invention are shown in Table 1.

TABLE 1
Potential Mimetics for this Invention

| | | | | Solvent | | |
|---|---|---|---|---|---|---|
| | | Boiling | Flash | Parameter | | Selection |
| Name | Formula | Point ° C. | Point ° C. | δ(cal/cm³)/ | Tg ° C. | Factors |
| Styrene | 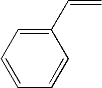 | 145-146 | 31 | 8.7 | 102 | HAP |
| Isobornyl Methacrylate | 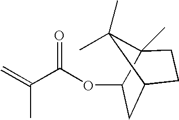 | 127-129 | 107 | 8.1 | 110 | Presently Preferred Selection |
| Dicyclopentenyl Methacrylate | 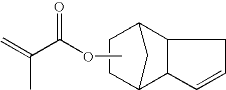 | 137 | 230 | — | — | An alternate, next preferred material |
| n-Butyl methacrylate | 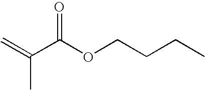 | 160-163 | 50 | 8.8 | 20 | Exhibiting a Low Tg, and low flash point |
| Ethyl methacrylate | 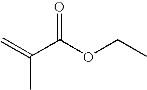 | 118-119 | 15 | 9.0 | 65 | Low flash point |
| n-Hexyl methacrylate | 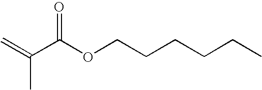 | 204 | 80 | 8.6 | −5 | Low Tg |
| Gyclohexyl methacrylate | 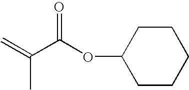 | 68-70 | 82 | | 83 | Boiling point lower than thermoset exotherm. |

While as indicated in Table 1, a number of potential commercially available styrene mimetics and their determinant properties have been considered in investigations on which this invention is based, the isobornyl methacrylate has been selected as the preferred baseline mimetic and is exemplified throughout this description for its superior properties, although the other compounds shown could also be used. In general, where methacrylate co-monomers are indicated in the above table, a acrylate counterpart may also be employed. For instance, ethacrylate monomers are also useful. These materials may also be used as low oligomers of from 2 to about 5 monomeric units.

### EXAMPLE AND TESTING RESULTS

Gelcoat formulations were prepared according to this invention utilizing a Conn Blade Intensive Type w/Teeth (ITT) a medium/high shear dispersion mixer rotating at 1,000 RPM. Spray evaluation was conducted utilizing a standard ES Gelcoat Cup Gun at with a No. 6 tip with an operating pressure of 50 psi. The low quantity required per application via the cup gun, ˜1 quart for the cup gun, vs. ˜1 gallon for the production gun, and the rapid change time per formulation, make it a more suitable tool for evaluations. Previous experience has show good correlation between the cup gun and the production gun in terms of gel coat application. Spray and application evaluations were conducted in a shop environment with a mean temperature of 70° F. The optimum K-monomer parts per hundred parts of base resin was derived under these conditions, and was found to be between 10 and 30 pph base.

A spray-optimized gelcoat formulation prepared according to this invention is shown in Table 2.

TABLE 2
Gel Coat Formulation
Exterior Gelcoat: White pigmented

| Component | Description | MFG | Parts/wt |
|---|---|---|---|
| Base Resin | DCPD Based Polyester | Verdant | 100 |
| Gloss Impact | CN965 Urethane Acrylate | Sartomer | 10 |
| Surface Engergy | SR489 Tridecyl Acryate | Sartomer | 1 |
| Hardness | SR423 Isobornyl Methacrylate | Sartomer | 17 |
| UV Stabilizer | TINUVIN 5050 | Ciba | 1 |
| Promoter | Polycure 503 | OMG | 0.645 |
| Promoter | n,n-Dimethylacetoacetamide | Eastman | 1.29 |
| | (DMAA) | | |
| Thix Modifier | Aerosil 200 | Hul | 3 |
| Pigment | CF-1004 White | Plasticolors | 12.9 |
| Initiator | Luperox DHD-9 | Autofina | 2 |

Verification of the application parameters was followed by quantification of the physical properties of the gelcoat. Thick (0.125″) samples were prepared for testing by casting. The test matrix is shown in Table 3, and the results of testing are shown in Table 4.

TABLE 3
PROCEDURES FOR MECHANICAL/PHYSICAL DATA
IN CURED STATE

| Properties | Unit | Test Method |
|---|---|---|
| Sprayability | Observation | ES-Cup Gun |
| Gel Time | Min. | ASTM2471-99* |
| Tack Time | Min. | ** |
| Tensile strength | Psi | ASTM D638 |
| Tensile elongation | % | ASTM D638 |
| Tensile modulus | Psi | ASTM D638 |
| Flexural strength | Psi | ASTM D790 |
| Flexural modulus | Psi | ASTM D790 |
| % Deflection | % | ASTM D790 |
| Hardness, Barcol | 934-1 | |
| Heat distortion temp. | ° C. | ASTM D648 |
| *Standard Test Method for Gel Time and Peak Exothermic Temperature of Reacting Thermoset Resins. | | |
| **A standard “tack test” is simply to press a thumb onto the coating. If after removing the thumb you leave an imprint is left but without removing the resin (which would now be on the thumb), then the coating has reached its tack time. | | |
| # If the thumb does not leave a print, this is past the tack time. The laminating process should begin prior to passing the tack time to insure formation of a covalent bond between the gelcoat and the substrate laminate. However, the | | |
| # laminate is applied prior to reaching the tack time, the laminate may be pressed through the then “too soft” pre-tack-time coating. | | |

TABLE 4
Mechanical/physical data for Example in cured state

| | Inventive | Conventional | | |
|---|---|---|---|---|
| Properties | Gelcoat | gelcoat | Unit | Test Method |
| Gel Time | 8 | 8 | Min. | Verdant |
| Tack Time | 60 | 45 | Min. | Verdant |
| Tensile strength | 4,720 | ˜8,200 | psi | ASTM |
| | | | | D638 |
| Tensile elongation | 2.8 | 2.9 | % | ASTM |
| | | | | D638 |
| Tensile modulus | 246,500 | N/A | psi | ASTM |
| | | | | D638 |
| Flexural strength | 9,730 | ˜12,240 | psi | ASTM |
| | | | | D790 |
| Flexural modulus | 512,200 | ˜518,000 | psi | ASTM |
| | | | | D790 |
| % Deflection | 13.1 | N/A | % | ASTM |
| | | | | D790 |
| Volume shrinkage | 0.7 | 6 | % | ASTM |
| | | | | D792 & |
| | | | | ASTM 1475 |
| Hardness, Barcol | 35 | 35-40 | 934-1 | |
| Heat distortion temp. | 55 | 60-100 | ° C. | ASTM |
| | | | | D648 |

A standard QUV accelerated weathering tester was next used to simulate accelerating weathering. QFS-40 lamps (UV-B) were used. These lamp produce the shortest wavelengths found in sunlight that strikes the earth. The typical output spectrum of these lamps is shown to the right. The spectrum shows that QFS-40 lamps produce considerably higher output energy between 270 nm and 325 nm than natural sunlight.

A cyclic program of 8 hours UV radiation at 60° C. followed by 4 hours condensation (no UV) at 40° C. was used. Data from the test is summarized in Table 5 and represents ˜6 months of exposure. The results indicated excellent color stability with good gloss retention.

TABLE 5
SUMMARY OF WEATHERING FOR EXAMPLE GEL COAT PANELS

| Property Tested | Unexposed Controls | Exposed Panels |
|---|---|---|
| Gloss Retention (%) | | |
| Initial Gloss | 85.6 | 85.8 |
| @ 150 hrs | 85.5 (100%) | 80.0 (93.2%) |
| @ 500 hrs | 83.8 (97.9%) | 59.2 (69.0%) |
| UV Color Stability (ΔYI) | | |
| Initial YI | 6.16 | 6.28 |
| @ 150 hrs | 6.29 (0.13) | 6.68 (0.40) |
| @ 500 hrs | 6.33 (0.17) | 6.66 (0.38) |

As indicated in Table 1, above, this invention may employ various acrylate or methacrylate ester components having from 2 to 4 carbon atom alkyl substituent radicals depending thereon, coupled with a 5 to 10 carbon atom containing mono or dicyclic alkyl or alkenyl ester radical, and carrying in turn one or more optional alkyl substituent of from about 1 to 3 carbon atoms. Of these it is presently preferred to employ the C₁₀ isobornyl embodiment. These materials may be added and employed as monomers or as low oligomers of from up to about 2 to 5 monomer units.

The invention may then utilized via conventional techniques by applying the gel coat composition of this invention to a mold surface and applying to the gel coat while in a partially cured tacky state the fiber reinforced substrate so as to achieve a cohesive bond therebetween. Alternatively, the gel coat composition of this invention could be sprayed onto the uncured or semi-cured fiber reinforced substrate itself to achieve the same result.

Accordingly, it is to be understood that this invention is defined and limited only by the spirit and scope of the following claims.

1. A thermosettable in-mold exterior gel coat composition exhibiting low or no volatile organic content for use with molded plastic substrates, including fiber reinforced substrates, wherein said gel coat composition is composed of an ethynically unsaturated polyester resin and utilizing as a co-polymerizable reactive diluent therein an acrylate or methacrylate ester component having from 2 to 4 carbon atom alkyl substituent radicals depending thereon, coupled with a 5 to 10 carbon-atom-containing mono or dicyclic alkyl or alkenyl ester radical, and carrying in turn one or more optional alkyl substituents of from about 1 to 3 carbon atoms.

2. A thermosettable in-mold exterior gel coat composition exhibiting low or no volatile organic content for use with molded plastic substrates, including fiber reinforced substrates, wherein said gel coat composition is composed of an ethynically unsaturated polyester resin and utilizing as a co-polymerizable reactive diluent therein an acrylated or a methacrylated isobornyl component.

3. A thermosettable in-mold exterior gel coat composition exhibiting low or no volatile organic content for use with molded plastic substrates, including fiber reinforced substrates, wherein said gel coat composition is composed of an ethynically unsaturated polyester resin and utilizing as a co-polymerizable reactive diluent therein a methacrylated isobornyl component.

4. The composition of claim 1 wherein said component is present as a substantially monomeric material.

5. The composition of claim 1 wherein at least a portion of said component is present as a substantially low oligomeric material of from about 2 to about 5 monomeric units.

6. A process for the application of an exterior gel coat to molded plastic substrates, including fiber reinforced substrates, wherein said gel coat composition is composed of an ethynically unsaturated polyester resin and utilizing as a co-polymerizable reactive diluent therein an acrylate or methacrylate ester component having from 2 to 4 carbon atom alkyl substituent radicals depending thereon, coupled with a 5 to 10 carbon-atom-containing mono or dicyclic alkyl or alkenyl ester radical, and carrying in turn one or more optional alkyl substituents of from about 1 to 3 carbon atoms, wherein said substrate is applied to said gel coat while it is in a tacky state of only partial cure so as to achieve a bonding between the substrate and the gel coat.
